(19) United States
(12) Patent Application Publication
(10) Pub. No.: US 2022/0121775 A1
(43) Pub. Date: Apr. 21, 2022

(54) SYSTEM AND METHOD FOR CONVERTING MACHINE LEARNING ALGORITHM, AND ELECTRONIC DEVICE

(71) Applicant: Beijing Realai Technology Co., Ltd., Beijing (CN)

(72) Inventors: Shizhen XU, Beijing (CN); Kunpeng WANG, Beijing (CN); Xiaofang ZHU, Beijing (CN); Liyuan LIU, Beijing (CN); Jiayu TANG, Beijing (CN); Tian TIAN, Beijing (CN)

(21) Appl. No.: 17/492,643

(22) Filed: Oct. 3, 2021

(30) Foreign Application Priority Data
Oct. 15, 2020 (CN) 202011099979.4

(51) Int. Cl. G06F 21/62; G06N 20/00; G06F 21/60; H04L 9/00

(52) U.S. Cl. CPC G06F 21/6245; H04L 9/008; G06F 21/602; G06N 20/00

(57) ABSTRACT

A system for converting a machine learning algorithm includes: a programmatic interface layer configured to construct a data-flow diagram of an original machine learning algorithm based on a preset data flow generation tool; an operator placement and evaluation module configured to calculate placement costs of each operator in the data-flow diagram when the operator is executed by different participants; a data-flow diagram dividing and scheduling module configured to divide the data-flow diagram into multiple sub-diagrams according to the placement costs, and schedule each of the sub-diagrams to a target participant for execution; and a compilation and execution layer configured to compile the sub-diagrams into a new data-flow diagram based on a greedy algorithm strategy, and generate an instruction for each operator in the new data-flow diagram to obtain a distributed privacy protection machine learning algorithm.

This application claims the priority to Chinese Patent Application No. 202011099979.4, titled “SYSTEM AND METHOD FOR CONVERTING MACHINE LEARNING ALGORITHM, AND ELECTRONIC DEVICE”, filed on Oct. 15, 2020 with the China National Intellectual Property Administration, which is incorporated herein by reference in its entirety.

### FIELD

The present disclosure relates to the technical field of computer, and particularly, to a system and a method for converting a machine learning algorithm, and an electronic device.

### BACKGROUND

Various training data used to drive development of AI models (such as Alpha Go, GPT-3) are often scattered in various institutions, so distributed privacy protection machine learning (also called federated learning) algorithm may be used to solve a problem of data privacy protection in geographically distributed data collection and model training.

One data segmentation manner in the distributed privacy protection machine learning algorithm is vertical segmentation. That is, data is distributed among different participants according to characteristics. For the distributed privacy protection machine learning algorithm having the vertical segmentation, an existing conversion method is to first implement an algorithm in an ordinary serial version, and then debug the algorithm and transplant it to a distributed privacy protection scenario, thereby machine converting the ordinary machine learning algorithm into the distributed privacy protection machine learning algorithm.

However, the above method has main problems of poor compatibility, high coupling and poor performance. Poor compatibility means that the distributed privacy protection machine learning algorithm, as an extension of the machine learning algorithm, has poor compatibility with a mainstream deep learning framework and is not convenient for a developer to use. High coupling means that the machine learning algorithm and a privacy protection computing protocol in the current distributed privacy protection scenario are tightly coupled, and almost every development requires careful analysis of an entire process of the original machine learning algorithm. High coupling also bring problems such as difficulty in application transplantation, difficulty in algorithm iteration, and poor scalability. Poor performance means that the distributed privacy protection machine learning algorithm is generally 100 or even 1000 times slower than the original stand-alone machine learning algorithm, which brings difficulties to actual implementation of the distributed privacy protection machine learning algorithm.

### SUMMARY

In order to solve the above technical problems or at least partially solve the above technical problems, a system and a method for converting a machine learning algorithm, and an electronic device are provided in the present disclosure.

A system for converting a machine learning algorithm is provided according to the disclosure. The system includes a programmatic interface layer, a data-flow diagram conversion layer, and a compilation and execution layer arranged from top to bottom. The data-flow diagram conversion layer includes an operator placement and evaluation module and a data-flow diagram dividing and scheduling module. The programmatic interface layer is configured to construct a data-flow diagram of an original machine learning algorithm based on a preset data flow generation tool. The data flow generation tool includes a Google-JAX computing framework. The data-flow diagram includes a series of operators. The operator placement and evaluation module is configured to calculate placement costs of each operator in the data-flow diagram when the operator is executed by different participants. The data-flow diagram dividing and scheduling module is configured to divide the data-flow diagram into multiple sub-diagrams according to the placement costs, and schedule each of the sub-diagrams to a target participant for execution. The compilation and execution layer is configured to compile the sub-diagrams into a new data-flow diagram based on a greedy algorithm strategy, and generate an instruction for each operator in the new data-flow diagram to obtain a distributed privacy protection machine learning algorithm.

In an embodiment, the operator includes a source operand. For any one of the operators in the data-flow diagram, the operator placement and evaluation module is further configured to: calculate an operator calculation cost of the operator, a communication cost of the source operand in the operator, and a calculation cost of the source operand in the operator by using a preset cost performance model, where the operator calculation cost indicates a calculation cost of calculation of the operator in plaintext or ciphertext, the communication cost of the source operand indicates whether the source operand needs communication and whether an communication object is plaintext or ciphertext; and determine placement costs of the operator when the operator is executed by different participants based on the operator calculation cost, the communication cost of the source operand and the calculation cost of the source operand.

In an embodiment, the data-flow diagram dividing and scheduling module is further configured to: traverse all the operators in the data-flow diagram according to a breadth-first search algorithm; and for any operator, determine a target participant for executing the operator according to a minimum placement cost of the operator; mark, in a process of the traversing, the target participant corresponding to each of the operators in sequence to obtain marking information, where the marking information indicates a correspondence between the operators and the target participants and indicates a topological order in which the operators are traversed; divide the data-flow diagram into multiple sub-diagrams according to the marking information, where each sub-diagram includes multiple which are corresponding to the same target participant and which are consecutive after the operators are topologically ordered; and schedule, for each of the sub-diagrams, the target participant corresponding to the sub-diagram to execute the sub-diagram according to the marking information.

In an embodiment, the data-flow diagram dividing and scheduling module is further configured to: add, if it is determined that the source operand in a current operator needs communication in a process of calculating the communication cost of the source operand, a communication operator before a calculation process of the current operator to obtain a new operator; add, if it is determined that the source operand in the current operator needs encrypted communication in the process of calculating the communication cost of the source operand, an encryption operator before the added communication operator to obtain a new operator; and transform a sub-diagram containing the new operator based on the new operator.

In an embodiment, the data-flow diagram conversion layer further includes a sub-diagram optimization module configured to optimize a plaintext calculation part of the sub-diagram.

In an embodiment, the compilation and execution layer includes a ciphertext calculation primitive module, a communication primitive module and a calculation and compilation module. The ciphertext calculation primitive module is configured to generate a calculation instruction for a first target operator in the new data-flow diagram by using a semi-homomorphic encryption algorithm library or a fully homomorphic encryption algorithm library. The first target operator is an operator on which encryption/decryption calculation and/or ciphertext calculation is to be performed. The communication primitive module is configured to generate a calculation instruction for a second target operator by using a communication library. The second target operator is an operator used for communication between different participants. The calculation and compilation module is configured to generate a calculation instruction for a third target operator by using a preset compilation tool. The third target operator is an operator on which plaintext calculation is to be performed.

In an embodiment, the compilation and execution layer is further configured to perform following compiling operations on each of the operators in the new data-flow diagram based on the greedy algorithm strategy: determining whether the source operand in a current operator communicates, whether a destination operand in the current operator communicates and whether an encryption status of the current operator is the same as an encryption status of an existing to-be-compiled operator cache, where the destination operand is a result operand calculated from the source operand in the operator; appending the current operator to a new to-be-compiled operator cache, in a case that the source operand in the current operator does not communicate, the destination operand in the current operator does not communicate and the encryption status of the current operator is the same as the encryption status of the existing to-be-compiled operator cache; jointly compiling the current operator and the existing to-be-compiled operator cache and emptying the existing to-be-compiled operator cache, in a case that the source operand in the current operator does not communicate, the destination operand in the current operator communicates and the encryption status of the current operator is the same as the encryption status of the existing to-be-compiled operator cache; compiling the existing to-be-compiled operator cache and setting the current operator as a new to-be-compiled operator cache, in a case that the source operand in the current operator does not communicate, the destination operand in the current operator does not communicate and the encryption status of the current operator is different from the encryption status of the existing to-be-compiled operator cache, or in a case that the source operand in the current operator communicates, the destination operand in the current operator does not communicate and the encryption status of the current operator is different from the encryption status of the existing to-be-compiled operator cache, or in a case that the source operand in the current operator communicates, the destination operand in the current operator does not communicate and the encryption status of the current operator is the same as the encryption status of the existing to-be-compiled operator cache; compiling the existing to-be-compiled operator cache and the current operator separately and emptying the existing to-be-compiled operator cache, in a case that the source operand in the current operator does not communicate, the destination operand in the current operator communicates and the encryption status of the current operator is different from the encryption status of the existing to-be-compiled operator cache, or in a case that the source operand in the current operator communicates, the destination operand in the current operator communicates and the encryption status of the current operator is different from the encryption status of the existing to-be-compiled operator cache, or in a case that the source operand in the current operator communicates, the destination operand in the current operator communicates and the encryption status of the current operator is the same as the encryption status of the existing to-be-compiled operator cache.

A method for converting a machine learning algorithm is provided according to the disclosure. The method includes: constructing a data-flow diagram of an original machine learning algorithm based on a preset data flow generation tool, where the data flow generation tool includes a Google-JAX computing framework, and the data-flow diagram includes a series of operators; calculating placement costs of each operator in the data-flow diagram when the operator is executed by different participants; dividing the data-flow diagram into multiple sub-diagrams according to the placement costs, and scheduling each of the sub-diagrams to a target participant for execution; and compiling the sub-diagrams into a new data-flow diagram based on a greedy algorithm strategy, and generating an instruction for each operator in the new data-flow diagram to obtain a distributed privacy protection machine learning algorithm.

An electronic device is provided according to the disclosure. The electronic device includes the system for converting a machine learning algorithm described above.

Compared with the conventional technology, the technical solutions provided by the embodiments of the present disclosure have the following advantages.

The system and method for converting the machine learning algorithm, and the electronic device are provided by embodiments of the present disclosure. The system includes a programmatic interface layer, a data-flow diagram conversion layer, and a compilation and execution layer. The data-flow diagram conversion layer includes an operator placement and evaluation module and a data-flow diagram dividing and scheduling module. The programmatic interface layer is configured to construct a data-flow diagram of an original machine learning algorithm based on a preset data flow generation tool (such as a Google-JAX computing framework). The data-flow diagram includes a series of operators. The operator placement and evaluation module is configured to calculate placement costs of each operator in the data-flow diagram when the operator is executed by different participants. The data-flow diagram dividing and scheduling module is configured to divide the data-flow diagram into multiple sub-diagrams according to the placement costs, and schedule each of the sub-diagrams to a target participant for execution. The compilation and execution layer is configured to compile the sub-diagrams into a new data-flow diagram based on a greedy algorithm strategy, and generate an instruction for each operator in the new data-flow diagram to obtain a distributed privacy protection machine learning algorithm. In the conversion mode of the above algorithm, the programmatic interface layer and the compilation and execution layer support the existing deep learning frameworks, thereby improving compatibility with the mainstream deep learning framework. The process, from an operation that the programming interface layer generates the data-flow diagram of the original machine learning algorithm to an operation that the compilation and execution layer generates the new data-flow diagram and transforms the new data-flow diagram to obtain the distributed privacy protection machine learning algorithm, expresses a relationship between the machine learning algorithm and the corresponding distributed privacy protection machine learning algorithm from a perspective of the underlying data-flow diagram, and completes the automatic conversion between the machine learning algorithm and the corresponding distributed privacy protection machine learning algorithm through the data-flow diagram conversion. The data-flow diagram conversion is universal and can be adapted to multiple upper layer machine learning algorithms, thereby reducing coupling between the machine learning algorithm and a privacy protection computing protocol. The data-flow diagram conversion layer calculates the placement costs of the operators, and divides the data-flow diagram into the sub-diagrams according to the placement costs, and schedule each of the sub-diagrams to a target participant for execution. In this way, computing performance of the distributed privacy protection machine learning algorithm can be effectively improved.

### BRIEF DESCRIPTION OF THE DRAWINGS

The drawings herein are incorporated into the specification and constitute a part of the specification. The drawings show embodiments of the present disclosure. The drawings and the specification are used to explain the principle of the present disclosure.

In order to more clearly explain the embodiments of the present disclosure or the technical solutions in the conventional art, the drawings used in the description of the embodiments or the conventional art are briefly introduced below. Apparently, for those skilled in the art, other drawings can be obtained according to the provided drawings without any creative effort.

FIG. 1 is a schematic structural diagram of a system for converting a machine learning algorithm provided by an embodiment of the present disclosure;

FIG. 2 is a schematic diagram of a logistic regression algorithm provided by an embodiment of the present disclosure;

FIG. 3 is a schematic structural diagram of a system for converting a machine learning algorithm provided by another embodiment of the present disclosure;

FIG. 4 is a schematic diagram of a process of calculating placement cost provided by an embodiment of the present disclosure;

FIG. 5 is a schematic diagram of dividing and scheduling a data-flow diagram provided by an embodiment of the present disclosure; and

FIG. 6 is a flow chart of a compilation operation performed on the data-flow diagram provided by an embodiment of the present disclosure.

102—programmatic interface layer; 104—data-flow diagram conversion layer; 1042—operator placement and evaluation module; 1044—data-flow diagram dividing and scheduling module; 1046—sub-diagram optimization module; 106—compilation and execution layer; 1062—ciphertext calculation primitive module; 1064—communication primitive module; 1066—calculation and compilation module.

### DETAILED DESCRIPTION

In order to make the purposes, features, and advantage of the present disclosure more apparent and easy to understand, the technical solutions in the embodiments of the present disclosure will be described clearly and completely hereinafter. It should be noted that the embodiments of the present disclosure and the features in the embodiments can be combined with each other if there is no conflict.

In the following detailed description, numerous specific details are set forth in order to provide thorough understanding of the present disclosure. However, the present disclosure may also be implemented in other ways different from those described here. Obviously, the embodiments in the specification are only a part of the embodiments of the present disclosure, rather than all the embodiments.

Big data-driven AI applications such as Alpha Go and GPT-3 have demonstrated revolutionary practical effects in their respective fields. There is no doubt that a large amount of training data is one of the most important factors driving development and iteration of these AI models. But reality is that all kinds of data are often scattered in various institutions. Collecting these data for model training often faces risks in terms of privacy protection. Distributed privacy protection machine learning (also called federated learning) algorithm is one of solutions to solve geographically distributed data collection and model training.

A data segmentation manner of a distributed privacy protection machine learning algorithm may include horizontal segmentation which means that data is distributed among different participants according to ID, and vertical segmentation which means that data is distributed among different participants according to characteristics. For the horizontal segmentation, each participant owns the entire model, and model parameter update is communicated only in a privacy-protected manner (similar to data parallelism). For the vertical segmentation, each participant owns a part of the model, and multiple participants sequentially execute some sub-modules of a model process, intermediate results need to be communicated frequently in a privacy-preserving manner (similar to model parallelism). It should be noted that a design of the distributed privacy protection machine learning algorithm having vertical segmentation is more complicated. Because it needs to carefully analyze an entire algorithm process, schedule each sub-module to a participant, and use a multi-party secure computing solution/cryptography solution to make data of each participant not be directly or indirectly leaked to other participants during training.

For the distributed privacy protection machine learning algorithm having vertical segmentation, existing conversion solutions can be divided into following two categories.

The first category of the conversion solution is to manually construct a corresponding distributed privacy protection machine learning algorithm for each machine learning algorithm, manually specify a calculation logic and communication content of each participant, and use of cryptographic schemes throughout distributed privacy protection machine learning algorithm. An example of the first category of the conversion solution is Federated Al Technology Enabler (FATE).

The second category of the conversion solution is to reuse the mainstream deep learning framework, and use secret sharing as underlying implementation for operators in the distributed privacy protection machine learning algorithm. The second category of the conversion solution only supports secret sharing, a single multi-party secure computing solution. The second category of the conversion solution generally requires manual implementation of a backpropagation algorithm, forces all participants to execute operators that only need to be executed by a certain participant, and lacks analysis and scheduling of the entire process of the distributed privacy protection algorithm. An example of the second category of the conversion solution is TF-Encrypted framework.

In the above two categories of the conversion solutions, an existing development process of the distributed privacy protection machine learning algorithm is to first implement an algorithm in an ordinary serial version, and then debug the algorithm and transplant it to a distributed privacy protection scenario, thereby machine converting the ordinary machine learning algorithm into the distributed privacy protection machine learning algorithm. Transplantation refers specifically to use of a communication/computing interface provided in the conversion solutions to re-implement the calculation/communication logic of each participant, or to reconstruct a new data-flow diagram containing each participant according to a new operator provided by the framework. Transplantation is prone to errors and needs to be debugged in a distributed environment. Further, maintenance and update of the algorithm need to repeat this transplantation process.

In summary, the above solutions mainly have following three defects.

1. Poor compatibility. The mainstream deep learning framework has been accepted by a machine learning developer, and the operators and automatic backpropagation algorithm provided by the mainstream deep learning framework greatly facilitate development of a machine learning program. The distributed privacy protection machine learning algorithm, as an extension of the machine learning algorithm, is not well compatible with the mainstream deep learning framework and is not convenient for the developer to use.

2. High coupling. The machine learning algorithm and the privacy protection computing protocol in a current distributed privacy protection scenario are tightly coupled, and almost every development requires careful analysis of an entire process of the original machine learning algorithm. High coupling also bring problems such as difficulty in application transplantation, difficulty in algorithm iteration, and poor scalability.

3. Poor performance. The distributed privacy protection machine learning algorithm is generally 100 or even 1000 times slower than the original stand-alone machine learning algorithm, a reason is that the privacy protection protocol introduces a large number of communications operations, and multi-party secure computing solution operations/cryptographic solution operations, which brings difficulties to actual implementation of the distributed privacy protection machine learning algorithm.

Therefore, in order to improve at least one of the above-mentioned problems, a system and a method for converting a machine learning algorithm, and an electronic device are provided by embodiments of the present disclosure. The embodiments of the present disclosure are described in detail below.

### Embodiment 1

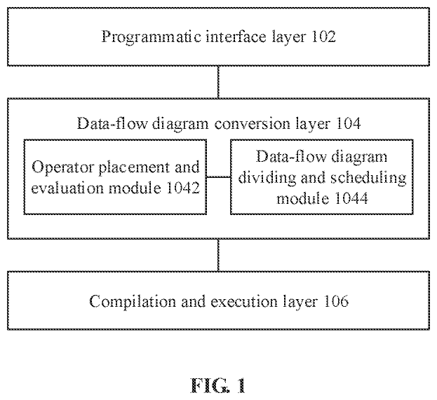

Referring to a schematic structural diagram of a system for converting a machine learning algorithm illustrated in FIG. 1, a system for converting a machine learning algorithm provided by an embodiment of the present disclosure may include a programmatic interface layer 102, a data-flow diagram conversion layer 104, and a compilation and execution layer 106 arranged from top to bottom. The data-flow diagram conversion layer may include, but not limited to, an operator placement and evaluation module 1042 and a data-flow diagram dividing and scheduling module 1044.

In order to better understand a working principle of the system, the three layers forming the system are described in detail as follows.

The programmatic interface layer is configured to construct a data-flow diagram of an original machine learning algorithm based on a preset data flow generation tool. The data-flow diagram includes a series of operators. Each operator includes: a source operand, an operator name and an output result. The output result may also be called a destination operand, which is a result operand calculated from the source operand. The data flow generation tool includes a deep learning framework, such as Google-JAX computing framework, Tensor Flow, and PyTorch.

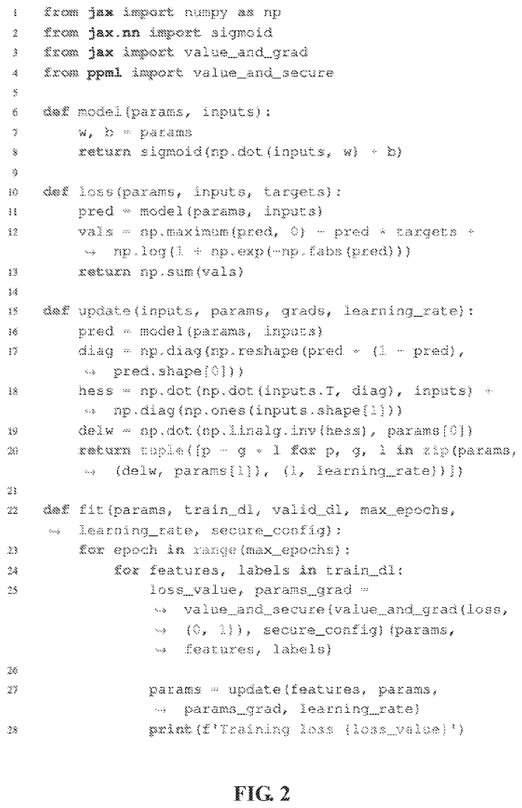

Specifically, the programmatic interface layer provides a large number of operator interfaces for a user to construct a variety of ordinary original machine learning algorithms. The data-flow diagram of the original machine learning algorithm generated by the programmatic interface layer is sent to the data-flow diagram conversion layer for analyzing. In this embodiment, a logistic regression algorithm illustrated in FIG. 2 is taken an example of the original machine learning algorithm. The logistic regression algorithm is obtained by combining some operator interfaces provided by the programmatic interface layer. Definition methods, of a model prediction function defined in sixth line of code, a model loss function defined in tenth line of the code, and an optimization method defined in fifteenth line of the code in FIG. 2, are the same as an existing Google-JAX/Numpy programming method. Due to a front end of JAX uses a programmatic interface similar to Numpy library, it is very consistent with usage habits of a python machine learning developer. Based on this, the programmatic interface layer provided in this embodiment can support the existing mainstream deep learning framework and improve compatibility of the system.

It should may understood that, in addition to using Google-Jax as a data flow generation tool, the programmatic interface layer may also use other data flow generation tools, such as Tensor Flow, PyTorch and other deep learning frameworks. The programmatic interface layer may also customize a front-end interface and a data-flow diagram format.

Regarding the data-flow diagram conversion layer, refer to twenty-fifth line of the code in FIG. 2, which means entering the data-flow diagram conversion layer. Specifically, a value_and_secure function acts on another function, and an operation of conversion to the distributed privacy protection machine learning is performed on the data-flow diagram at a bottom of the another function. It may also be understood that the value_and_secure function is used to modify another function and trigger an operation of conversion to the distributed privacy protection for the another function. The value_and_secure function may modify a variety of functions, thereby bringing scalability. In addition, it should be noted that the update function illustrated in twenty-seventh line of FIG. 2 is executed independently by one participant in this embodiment. For this type of function that is executed independently by one participant, it may not be modified by value_and_secure, such that it is more convenient for the user to flexibly write a corresponding machine learning algorithm.

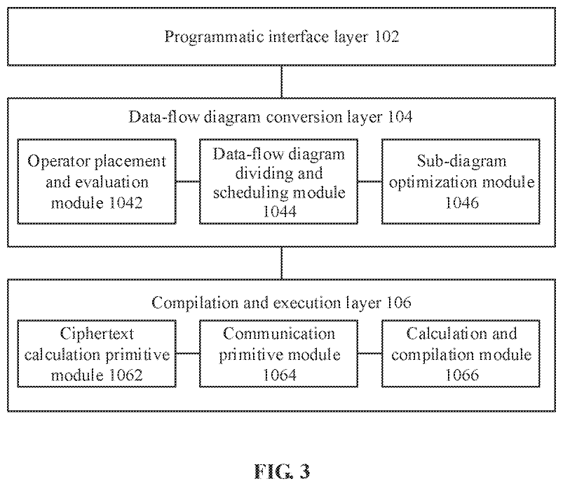

Referring to FIG. 3, the data-flow diagram conversion layer 104 may include the operator placement and evaluation module 1042 and the data-flow diagram dividing and scheduling module 1044, and may also include a data-flow diagram sub-diagram optimization module (referred to as a sub-diagram optimization module 1046 for short). By sequentially executing the operator placement and evaluation module 1042, the data-flow diagram dividing and scheduling module 1044 and the subgraph optimization module 1046 in the data-flow diagram conversion layer, the data-flow diagram of the original machine learning algorithm is converted to the data-flow diagram of a corresponding high-performance distributed privacy protection machine learning algorithm.

The operator placement and evaluation module is configured to calculate placement costs of each operator in the data-flow diagram when the operator is executed by different participants.

For any operator in the data-flow diagram, the operator placement and evaluation module is specifically configured to implement following step 1 and step 2.

In step 1, calculate an operator calculation cost of the operator, a communication cost of the source operand in the operator, and a calculation cost of the source operand in the operator by using a preset cost performance model.

The operator calculation cost indicates a calculation cost of calculation of the operator in plaintext or ciphertext.

The communication cost of the source operand indicates whether the source operand needs communication, whether encryption is needed for the source operand before communication and whether an communication object that communicates with the source operand is plaintext or ciphertext. When the source operand in the operator leaks private data of other participant, the source operand is encrypted by means of multi-party secure calculation and/or cryptography. In this case, the communication cost of the source operand may be calculated.

In this embodiment, the cost performance model may be a static model, that is, it is considered that the operator calculation cost, the communication cost of the source operand, and the calculation cost of the source operand are known in advance, and the above cost may be statically analyzed. The above static model is for example offline module in PORPLE performance model. The cost performance model may also be a dynamic model, that is, it is considered that the operator calculation cost, the communication cost of the source operand, and the calculation cost of the source operand need to be analyzed in real time during operation and they may change in real time during operation. The above dynamic model is for example online module of the PORPLE performance model.

In step 2, determine placement costs of the operator when the operator is executed by different participants based on the operator calculation cost, the communication cost of the source operand and the calculation cost of the source operand.

Following execution costs, including the operator calculation cost, the communication cost of the source operand, and the calculation cost of the source operand, of each operator corresponding to each participant are calculated by using the cost performance model and are calculated according to a way of dynamic programming and are calculated along a dependency relationship in the data-flow diagram. Then, a sum of the above three execution costs may be determined as the placement cost.

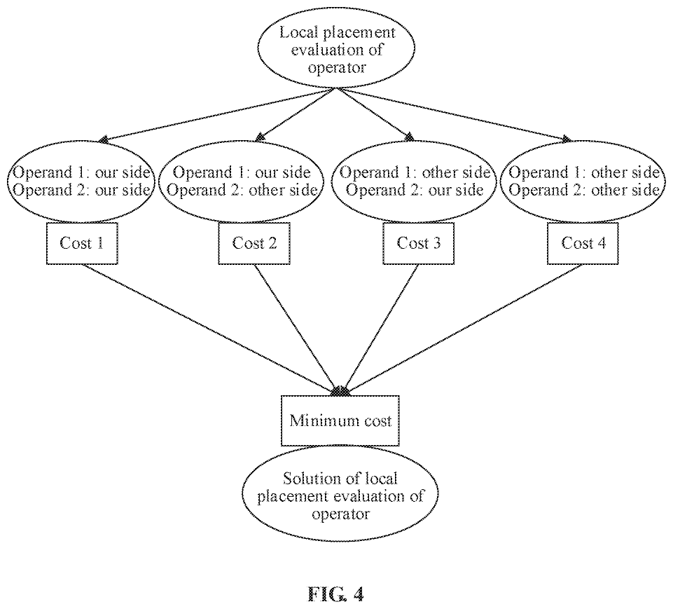

A method for determining the placement cost by using the cost performance model is illustrated in FIG. 4. According to a source of the source operand, there are 2ⁿ possibilities for the placement cost of the operator, where n is the number of the source operands in the operator. For example, FIG. 4 illustrate a case of an operator with two source operands, and there are four possibilities for the placement cost. The cost performance model may determine the minimum placement cost as a target placement cost.

In practice, there may be a scenario where the placement cost cannot be calculated. The incalculable placement cost means that a current placement method is not achievable. For example, for a first participant of two participants interacting with each other, when the operator is executed locally and the two source operands come from a second participant and the two source operands are performed with homomorphic encryption and the operator is not supported by a homomorphic encryption algorithm, the placement cost of the operator cannot be calculated and can be specifically expressed as infinity.

The data-flow diagram dividing and scheduling module is configured to divide the data-flow diagram into multiple sub-diagrams according to the placement costs, and schedule each of the sub-diagrams to a target participant for execution.

In an embodiment, the data-flow diagram dividing and scheduling module implements following steps (1) to (4) to achieve dividing and scheduling of a data-flow diagram.

In step (1), traverse all the operators in the data-flow diagram according to a breadth-first search algorithm; and for any operator, determine a target participant for executing the operator according to a minimum placement cost of the operator. The determined target participant for executing the operator may also be referred to as a placement position of the operator.

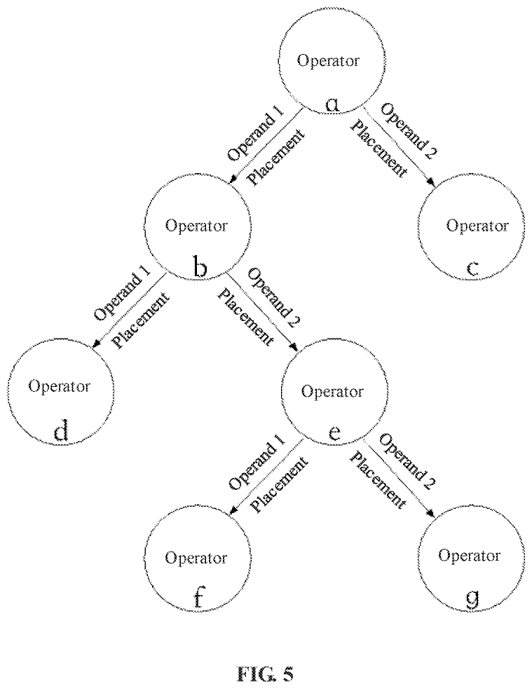

There are multiple possibilities for the placement position of each operator. In this embodiment, the minimum placement cost is selected from the multiple placement costs, to determine the target participant for executing the operator. After all the operators in the data-flow diagram are traversed by using the breadth-first search algorithm, the placement position of each operator with the minimum placement cost may be determined, so that entire cost of the data-flow diagram is minimized. Referring to FIG. 5, a root node (such as operator a) represents a target output whose calculation position is predetermined. The placement position of the operator is determined by selecting the minimum placement cost of the operator. After determining the placement position of the source operand (that is, output results of operators b and c) in operator a, because the source operand is also an output of another operator (in this case, the operators b and c), a calculation position of the another operator (in this case, the operators b and c) may be determined. By analogy, the breadth-first search algorithm is used to traverse all operators in the data-flow diagram and determine the target participant of each operator.

In step (2), mark, in a process of the traversing, the target participant corresponding to each of the operators in sequence to obtain marking information. The marking information indicates a correspondence between the operators and the target participants and indicates a topological order in which the operators are traversed.

In step (3), divide the data-flow diagram into multiple sub-diagrams according to the marking information. Each sub-diagram includes multiple operators which are corresponding to the same target participant and which are consecutive after the operators are topologically ordered.

In step (4), schedule, for each of the sub-diagrams, the target participant corresponding to the sub-diagram to execute the sub-diagram according to the marking information.

The marking information can reflect a topological order in which the operators are traversed, therefore, scheduling the sub-diagrams according to the marking information can ensure an execution order of the data-flow diagram. The data-flow diagram dividing and scheduling module adopts the topological order to ensure execution dependence, and can perform sequence change processing on the operators in the data-flow diagram while ensuring the topological order, which also facilitates compilation and optimization of subsequent data-flow diagrams.

In a process of calculating the communication cost of the source operand, in a scenario where the source operand needs communication and the communication is divided into general communication (that is, non-encrypted communication, usually directly referred to as communication) and encrypted communication, the data-flow diagram dividing and scheduling module in this embodiment may also be configured to:

add, if it is determined that the source operand in a current operator needs communication (this communication is the aforementioned general communication) in a process of calculating the communication cost of the source operand, a communication operator before a calculation process of the current operator to obtain a new operator, where the communication operator is an operator added to the source operand; and transform a sub-diagram containing the new operator based on the new operator;

add, if it is determined that the source operand in the current operator needs encrypted communication in the process of calculating the communication cost of the source operand, an encryption operator before the added communication operator to obtain a new operator, where the encryption operator is an operator added before the communication operator of the source operand based on the added communication operator; and transform a sub-diagram containing the new operator based on the new operator.

In this embodiment, the multi-party secure computing/cryptographic communication operator is added, and the sub-diagram is transformed in a multi-party secure computing/cryptographic mode to protect data privacy. The new operator obtained by the adding operation or the transforming operation together with the sub-diagrams of the data-flow diagram obtained by dividing express the distributed privacy protection machine learning process.

The sub-diagram optimization module is configured to optimize a plaintext calculation part of the sub-diagram. The sub-diagram optimization module may reuse a data-flow diagram optimization module in the mainstream deep learning framework, and perform data-flow diagram optimization processing such as common sub-expression elimination and operand fusion on the plaintext calculation part of the sub-diagram. The above-mentioned data-flow diagram optimization module may have multiple implementations, such as TVM and TASO.

A realization function of the compilation and execution layer is provided in this embodiment. The compilation and execution layer is configured to compile the sub-diagrams into a new data-flow diagram based on a greedy algorithm strategy, and generate an instruction for each operator in the new data-flow diagram to obtain the distributed privacy protection machine learning algorithm.

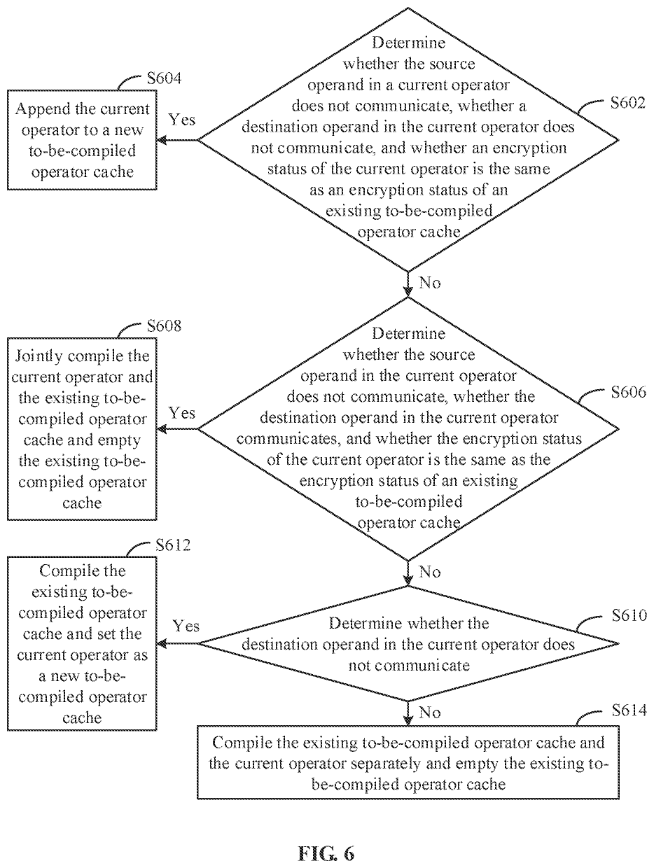

The compilation and execution layer compiles the sub-diagrams in the new data-flow diagram one by one in the topological order based on the greedy algorithm strategy, and maximizing the number of operators in each backend. A flow of a compilation method is illustrated in FIG. 6, that is, based on the greedy algorithm strategy, the following compilation operations (i.e., steps S602 to S614) are performed on each of the operators in the new data-flow diagram.

In step S602, determine whether the source operand in a current operator does not communicate, whether a destination operand in the current operator does not communicate, and whether an encryption status of the current operator is the same as an encryption status of an existing to-be-compiled operator cache.

If all determination results in step S602 are positive determinations, the following step S604 is executed, otherwise, the following steps S606 to S614 are executed.

In step S604, append the current operator to a new to-be-compiled operator cache, in a case that the source operand in the current operator does not communicate, the destination operand in the current operator does not communicate and the encryption status of the current operator is the same as the encryption status of the existing to-be-compiled operator cache (for example, both the encryption status of the current operator and the encryption status of the existing to-be-compiled operator cache are an encrypted status or a non-encrypted status).

In step S606, determine whether the source operand in the current operator does not communicate, whether the destination operand in the current operator communicates, and whether the encryption status of the current operator is the same as the encryption status of an existing to-be-compiled operator cache. If all determination results in step S606 are positive determinations, the following step S608 is executed, otherwise, the following steps S610 to S614 are executed.

In step S608, jointly compile the current operator and the existing to-be-compiled operator cache and empty the existing to-be-compiled operator cache, in a case that the source operand in the current operator does not communicate, the destination operand in the current operator communicates and the encryption status of the current operator is the same as the encryption status of the existing to-be-compiled operator cache.

In step S610, determine whether the destination operand in the current operator does not communicate. The following step S512 is executed in a case that the destination operand in the current operator does not communicate. The following step S614 is executed in a case that the destination operand in the current operator communicates.

In step S512, compile the existing to-be-compiled operator cache and set the current operator as a new to-be-compiled operator cache in a case that the destination operand in the current operator does not communicate.

In step S614, compile the existing to-be-compiled operator cache and the current operator separately and empty the existing to-be-compiled operator cache in a case that the destination operand in the current operator communicates.

It can be seen from the above steps that the operators compiled by the current executable back-end includes the currently analyzed operators as much as possible, unless there is a communication need, such as the source operand needs to communicate, or the back-end changes, such as plaintext calculation is performed in the to-be-compiled operator cache, while ciphertext calculation is performed in the current operator.

As illustrated in FIG. 3, the compilation and execution layer may include: a ciphertext calculation primitive module 1062, a communication primitive module 1064, and a calculation and compilation module 1066.

The ciphertext calculation primitive module is configured to generate a calculation instruction for a first target operator in the new data-flow diagram by using a semi-homomorphic encryption algorithm library (such as Paillier, HELib, and MicroSoft-Seal homomorphic encryption algorithm library) or a fully homomorphic encryption algorithm library. The first target operator is an operator on which encryption/decryption calculation and/or ciphertext calculation is to be performed.

The communication primitive module is configured to generate a calculation instruction for a second target operator by using a communication library (such as gRPC, MPI, ZeroMQ, and Socket communication library). The second target operator is an operator used for communication between different participants.

The calculation and compilation module is configured to generate a calculation instruction for a third target operator by using a preset compilation tool. The third target operator is an operator on which plaintext calculation is to be performed. A compilation object of the calculation and compilation module is the operator on which plaintext calculation is to be performed, which implements ordinary compilation work, therefore, the calculation and compilation module may also be referred to as an ordinary calculation and compilation module.

From the above, the above embodiment describes the system for converting the machine learning algorithm provided for vertical data segmentation scenarios, which expresses a relationship between an ordinary original machine learning algorithm and the corresponding distributed privacy protection machine learning algorithm from a perspective of the underlying data-flow diagram, and completes the automatic conversion between the ordinary original machine learning algorithm and the corresponding distributed privacy protection machine learning algorithm through the data-flow diagram conversion. The data-flow diagram conversion is universal and can be adapted to multiple upper layer machine learning algorithms, reuse the existing mainstream deep learning framework to develop the machine learning algorithm process, and improve compatibility. From the perspective of the data-flow diagram, distributed privacy protection conversion may be understood as dividing the entire data-flow diagram into several sub-diagrams and distributing the sub-diagrams to participants, and ensuring that an interactive part (i.e., a communication part) of the sub-diagrams is carried out in a privacy-protected manner. Further, the system can adapt to a compilation and optimization method of the existing deep learning framework, and analyze an execution cost of the privacy protection machine learning algorithm in multiple participants through the model, thereby improving the calculation performance of the algorithm.

### Embodiment 2

Based on the system for converting the machine learning algorithm provided by the foregoing embodiment, a method for converting a machine learning algorithm is provided by this embodiment. The method may include: constructing a data-flow diagram of an original machine learning algorithm based on a preset data flow generation tool, where, the data flow generation tool includes a Google-JAX computing framework, and the data-flow diagram includes a series of operators; calculating placement costs of each operator in the data-flow diagram when the operator is executed by different participants; dividing the data-flow diagram into multiple sub-diagrams according to the placement costs, and scheduling each of the sub-diagrams to a target participant for execution; and compiling the sub-diagrams into a new data-flow diagram based on a greedy algorithm strategy, and generating an instruction for each operator in the new data-flow diagram to obtain a distributed privacy protection machine learning algorithm.

Implementation principles and technical effects of the method provided in this embodiment are the same as those of the foregoing embodiment. For a brief description, for the parts not mentioned in the method embodiment, please refer to the corresponding content in the foregoing system embodiment.

Furthermore, an electronic device is also provided in the embodiments of the present disclosure. The system for converting the machine learning algorithm according to embodiment 1 is provided on the electronic device.

It should be noted that the terms “first”, “second” and the like in the description are used for distinguishing an entity or operation from another entity or operation, but not intended to describe an actual relationship or order between these entities or operations. The terms “include”, “comprise” or any other variations are intended to cover non-exclusive “include”, thus a process, a method, an object or a device including a series of elements not only include the listed elements, but also include other elements not explicitly listed, or also include inherent elements of the process, the method, the object or the device. Without more limitations, a element defined by a sentence “include one . . . ” does not exclude a case that there is another same element in the process, the method, the object or the device including the described element.

The above are only specific implementations of the present disclosure, so that those skilled in the art can understand or implement the present disclosure. It is obvious for those skilled in the art to make many modifications to these embodiments. The general principle defined herein may be applied to other embodiments without departing from the spirit or scope of the present disclosure. Therefore, the present disclosure is not limited to the embodiments illustrated herein, but should be defined by the broadest scope consistent with the principle and novel features disclosed herein.

1. A system for converting a machine learning algorithm, comprising: a programmatic interface layer, a data-flow diagram conversion layer, and a compilation and execution layer arranged from top to bottom, wherein the data-flow diagram conversion layer comprises an operator placement and evaluation module and a data-flow diagram dividing and scheduling module,
the programmatic interface layer is configured to construct a data-flow diagram of an original machine learning algorithm based on a preset data flow generation tool, wherein the data flow generation tool comprises a Google-Java API for XML (Google-JAX) computing framework, and the data-flow diagram comprises a series of operators;
the operator placement and evaluation module is configured to calculate placement costs of each operator in the data-flow diagram when the operator is executed by different participants;
the data-flow diagram dividing and scheduling module is configured to divide the data-flow diagram into a plurality of sub-diagrams according to the placement costs, and schedule each of the sub-diagrams to a target participant for execution; and
the compilation and execution layer is configured to compile the sub-diagrams into a new data-flow diagram based on a greedy algorithm strategy, and generate an instruction for each operator in the new data-flow diagram to obtain a distributed privacy protection machine learning algorithm.

2. The system according to claim 1, wherein the operator comprises a source operand, for any one of the operators in the data-flow diagram, the operator placement and evaluation module is further configured to:
calculate an operator calculation cost of the operator, a communication cost of the source operand in the operator, and a calculation cost of the source operand in the operator by using a preset cost performance model, wherein, the operator calculation cost indicates a calculation cost of calculation of the operator in plaintext or ciphertext, the communication cost of the source operand indicates whether the source operand needs communication and whether an communication object is plaintext or ciphertext; and
determine placement costs of the operator when the operator is executed by different participants based on the operator calculation cost, the communication cost of the source operand and the calculation cost of the source operand.

3. The system according to claim 1, wherein the data-flow diagram dividing and scheduling module is further configured to:
traverse all the operators in the data-flow diagram according to a breadth-first search algorithm; and for any operator, determine a target participant for executing the operator according to a minimum placement cost of the operator;
mark, in a process of the traversing, the target participant corresponding to each of the operators in sequence to obtain marking information, wherein the marking information indicates a correspondence between the operators and the target participants and indicates a topological order in which the operators are traversed;
divide the data-flow diagram into a plurality of sub-diagrams according to the marking information, wherein each sub-diagram comprises a plurality of the operators which are corresponding to the same target participant and which are consecutive after the operators are topologically ordered; and
schedule, for each of the sub-diagrams, the target participant corresponding to the sub-diagram to execute the sub-diagram according to the marking information.

4. The system according to claim 2, wherein the data-flow diagram dividing and scheduling module is further configured to:
add, if it is determined that the source operand in a current operator needs communication in a process of calculating the communication cost of the source operand, a communication operator before a calculation process of the current operator to obtain a new operator;
add, if it is determined that the source operand in the current operator needs encrypted communication in the process of calculating the communication cost of the source operand, an encryption operator before the added communication operator to obtain a new operator; and
transform a sub-diagram containing the new operator based on the new operator.

5. The system according to claim 1, wherein the data-flow diagram conversion layer further comprises a sub-diagram optimization module configured to optimize a plaintext calculation part of the sub-diagram.

6. The system according to claim 1, wherein the compilation and execution layer comprises:
a ciphertext calculation primitive module configured to generate a calculation instruction for a first target operator in the new data-flow diagram by using a semi-homomorphic encryption algorithm library or a fully homomorphic encryption algorithm library, wherein the first target operator is an operator on which at least one of encryption/decryption calculation and ciphertext calculation is to be performed;
a communication primitive module configured to generate a calculation instruction for a second target operator by using a communication library, wherein the second target operator is an operator used for communication between different participants; and
a calculation and compilation module configured to generate a calculation instruction for a third target operator by using a preset compilation tool, wherein the third target operator is an operator on which plaintext calculation is to be performed.

7. The system according to claim 1, wherein the compilation and execution layer is further configured to perform following compiling operations on each of the operators in the new data-flow diagram based on the greedy algorithm strategy:
determining whether the source operand in a current operator communicates, whether a destination operand in the current operator communicates and whether an encryption status of the current operator is the same as an encryption status of an existing to-be-compiled operator cache, wherein the destination operand is a result operand calculated from the source operand in the operator;
appending the current operator to a new to-be-compiled operator cache, in a case that the source operand in the current operator does not communicate, the destination operand in the current operator does not communicate and the encryption status of the current operator is the same as the encryption status of the existing to-be-compiled operator cache;
jointly compiling the current operator and the existing to-be-compiled operator cache and emptying the existing to-be-compiled operator cache, in a case that the source operand in the current operator does not communicate, the destination operand in the current operator communicates and the encryption status of the current operator is the same as the encryption status of the existing to-be-compiled operator cache;
compiling the existing to-be-compiled operator cache and setting the current operator as a new to-be-compiled operator cache, in a case that the source operand in the current operator does not communicate, the destination operand in the current operator does not communicate and the encryption status of the current operator is different from the encryption status of the existing to-be-compiled operator cache, or in a case that the source operand in the current operator communicates, the destination operand in the current operator does not communicate and the encryption status of the current operator is different from the encryption status of the existing to-be-compiled operator cache, or in a case that the source operand in the current operator communicates, the destination operand in the current operator does not communicate and the encryption status of the current operator is the same as the encryption status of the existing to-be-compiled operator cache;
compiling the existing to-be-compiled operator cache and the current operator separately and emptying the existing to-be-compiled operator cache, in a case that the source operand in the current operator does not communicate, the destination operand in the current operator communicates and the encryption status of the current operator is different from the encryption status of the existing to-be-compiled operator cache, or in a case that the source operand in the current operator communicates, the destination operand in the current operator communicates and the encryption status of the current operator is different from the encryption status of the existing to-be-compiled operator cache, or in a case that the source operand in the current operator communicates, the destination operand in the current operator communicates and the encryption status of the current operator is the same as the encryption status of the existing to-be-compiled operator cache.

8. A method for converting a machine learning algorithm, comprising:
constructing a data-flow diagram of an original machine learning algorithm based on a preset data flow generation tool, wherein, the data flow generation tool comprises a Google-Java API for XML (Google-JAX) computing framework, and the data-flow diagram comprises a series of operators;
calculating placement costs of each operator in the data-flow diagram when the operator is executed by different participants;
dividing the data-flow diagram into a plurality of sub-diagrams according to the placement costs, and scheduling each of the sub-diagrams to a target participant for execution; and
compiling the sub-diagrams into a new data-flow diagram based on a greedy algorithm strategy, and generating an instruction for each operator in the new data-flow diagram to obtain a distributed privacy protection machine learning algorithm.

9. An electronic device comprising the system for converting a machine learning algorithm according to claim 1.
